(19) United States
(12) Patent Application Publication
(10) Pub. No.: US 2010/0162581 A1
(43) Pub. Date: Jul. 1, 2010

(54) LINEN FOLDING TEMPLATE

(76) Inventor: Roy K. Ward, Fortville, IN (US)

Correspondence Address: MAGINOT, MOORE & BECK, LLP;CHASE TOWER, 111 MONUMENT CIRCLE, SUITE 3250, INDIANAPOLIS, IN, 46204, US

(21) Appl. No.: 12/347,562

(22) Filed: Dec. 31, 2008

(51) Int. Cl. B43L 7/00

(52) U.S. Cl. 33/566

(57) ABSTRACT

A folding template for a fitted sheet includes is a generally rigid but foldable panel that is configured to match the unfolded size and shape of the fitted sheet. The template is provided with pre-determined orthogonal fold lines that automatically direct a person to make three orthogonal folds to reduce any size fitted sheet into a tight and neatly folded rectangle. The template panel is thin enough so that it does not add significantly to the thickness of the folded sheet. The panel is formed of a material that does not buckle against the pressure of the elastic bands in the fitted sheet.

### BACKGROUND

The fitted sheet is the most problematic of the household linens. While it is sometimes difficult to put a fitted sheet on a mattress, it is always difficult to fold the fitted sheet for storage. Only the most accomplished domestic technician is able to fold a fitted sheet into a neat and compact rectangle. This difficulty is accentuated the larger the fitted sheet. Folding a standard king size sheet is cumbersome but even the average person can produce a reasonably uniform folded rectangle or square. But folding a king size fitted sheet is a recipe for frustration and resignation. Most people settle for a somewhat wadded trapezoid that can be stuffed into the linen closet underneath a neatly folded standard sheet.

Various videos are available on the Internet that demonstrate proper techniques for producing a tightly and neatly folded fitted sheet of any size. However, these techniques are, frankly, outside the skill level and dexterity of the average person. Moreover, each of these video-demonstrated techniques require a greater degree of fastidiousness than most people are willing to commit just to fold a bed sheet.

Nevertheless, most people would prefer to have fitted sheets that are folded as neatly as the standard sheets. A properly folded sheet is more compact and easier to store with other linens. As a practical matter, a well-folded sheet avoids wrinkles, particularly where the sheet is made of a material that is easily wrinkled, such as cotton. Moreover, there is a certain aesthetic appeal or satisfaction to a neatly folded sheet.

In spite of all these benefits, most people continue to struggle with the unwieldy fitted sheet. Thus, there is a need for a device that can make folding a fitted sheet achievable by even the least adept among us.

### SUMMARY

The answer to the dilemma of folding a fitted sheet is met by a folding template. In one embodiment, the template is a generally rigid but foldable panel that is configured to match the unfolded size and shape of the fitted sheet. In one embodiment, the template is provided with pre-determined fold lines that automatically direct a person to make three folds that reduce any size fitted sheet into a tight and neatly folded rectangle. The template panel is thin enough so that it does not add significantly to the thickness of the folded sheet. The panel is formed of a material that does not buckle against the pressure of the elastic bands in the fitted sheet.

### DESCRIPTION OF THE FIGURES

FIG. 1 is a top plan view of a folding template for linens according to one embodiment of the invention.

FIG. 2 is a side view of the folding template shown in FIG. 1.

FIG. 3 is a top view of a folding template according to the present invention disposed within a fitted sheet.

FIG. 4 is a side view of a first fold accomplished with the folding template shown in FIG. 3.

FIG. 5 is a top view of the result following the first fold.

FIG. 6 is an end view of a second fold accomplished with the folding template.

FIG. 7 is a top view of the result following the second fold.

FIG. 8 is a plan view of a folding template according to a further embodiment.

### DESCRIPTION OF THE PREFERRED EMBODIMENTS

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

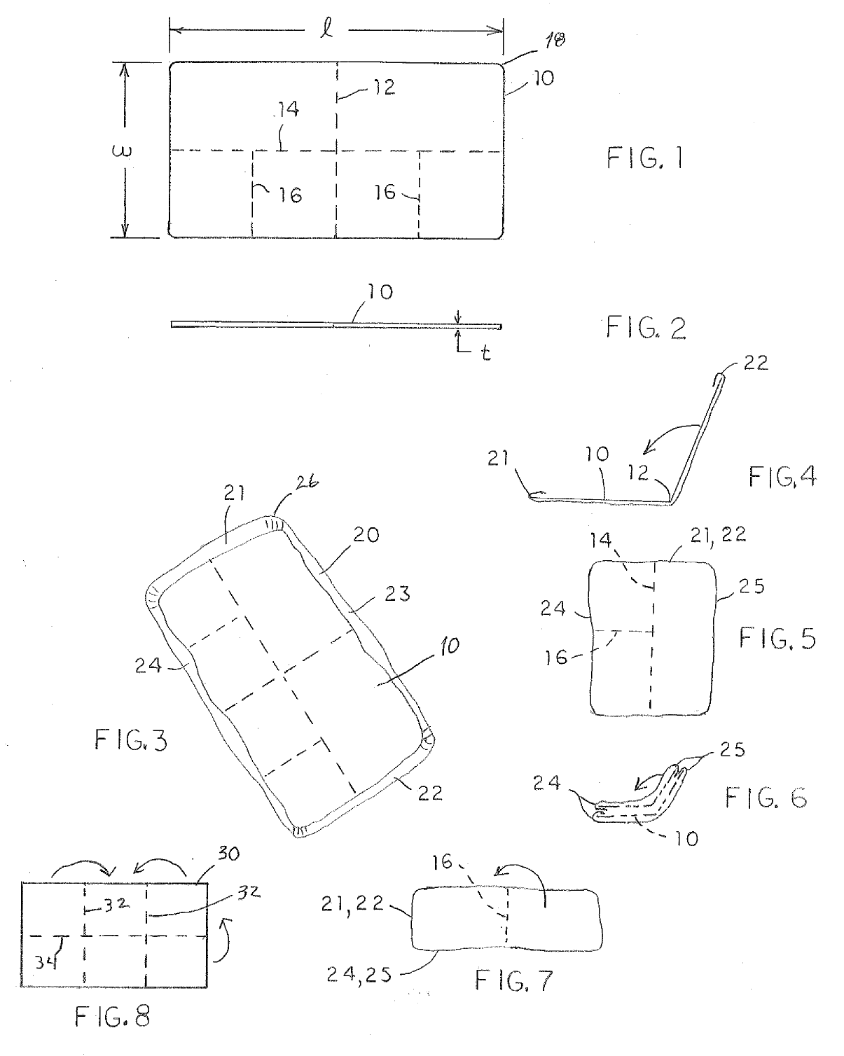

In one embodiment, a fitted sheet folding template includes a generally flat panel 10, as shown in FIGS. 1-2. The panel has a length l and width w that are generally equal to the dimensions of the fitted sheet when it is installed on a mattress. Due to the elastic bands in the fitted sheet, these dimensions of the panel 10 will be greater than the overall dimensions of the fitted sheet in its free state.

As shown in the plan view of FIG. 1, the panel 10 includes an arrangement of fold lines 12, 14 and 16. These fold lines are defined in the panel to permit repeated folding or pivoting about the fold line. Thus, the fold lines may be formed by a line of reduced thickness, by a line of reduced stiffness or by a mechanical hinge element. In one exemplary embodiment, the panel 10 has a thickness t (FIG. 2) while each fold line 12, 14 and 16 can have a thickness of about ½t. Thus, the fold lines may be formed as a “living hinge”. This approach is particularly well-suited for a panel 10 formed of a polymeric or plastic material, such as polypropylene that can withstand multiple bends about the living hinge without failure or tearing.

Alternatively, the fold lines may be defined by lines of reduced stiffness relative to the remainder of the panel 10. In one exemplary embodiment, this approach may be achieved by a row of score lines or perforations. As with the “living hinge” approach, the line of reduced stiffness is better suited for a polymeric or plastic material than for a cellulosic material, for instance.

The third approach of providing a mechanical hinge element may be implemented in panels formed of a wide range of materials. Each fold line may be provided with a plurality of hinge elements distributed along the length of the fold line, or by a hinge element spanning the length of the particular fold line. However, it is appreciated that a hinge element spanning an entire fold line can only be accomplished for the fold lines 16. Hinge elements for fold line 14 must be discontinued at the location of the other fold lines 12 and 16. Likewise, hinge elements for the fold line 12 must be discontinued at the fold line 14 to permit folding at that line. In a specific embodiment, the hinge elements may be thin plastic pintle-type hinges or may be “living hinge” strips that are affixed to the panel. With this approach the panel 10 itself is provided in segments corresponding to areas bounded by each of the fold lines 12, 14 and 16. Thus, as shown in FIG. 1, the three fold lines produce six panel segments that are connected by corresponding hinge elements.

The hinge lines 12, 14 and 16 are arranged so that the panel 10 may be first folded over onto itself at the first hinge line 12. The resulting folded panel is then again folded over onto itself along the second hinge line 14. Finally, the resulting folded panel is folded over along the third hinge line 16. More particularly, the fold lines are preferably defined parallel to a width or length dimension of the panel. Moreover, successive fold lines are defined orthogonal to each other. In other words, a successive fold is made at a perpendicular angle relative to the prior fold.

It can be appreciated that after each fold, the next fold line must be capable of making the fold over an increased thickness. For instance, after the first fold is made along fold line 12, the next fold along line 14 must be made with one half of the panel 10 overlapping the other half. Similarly, when the last fold is made along fold line 16, four layers of panel 10 must be folded. Thus, it is contemplated that the fold line 14 be configured to permit folding of a thicker folded panel, and that the fold line 16 is configured for an even thicker folded panel. For example, in the configuration in which each fold line is defined by a “living hinge”, the line of reduced thickness may have a width of about 0.05 inches. For a panel 10 having a thickness t of 0.06 inches, the resulting folded panel will have a thickness of at least twice the panel thickness, or about 0.12 inches. The “living hinge” for the second fold line 14 must be sized to accept a fold in a 0.12 inch thick stack so that the “living hinge” may have a width of about 0.15 inches. Similarly, the living hinge for the last fold line 16 may have a width of about 0.30 inches to achieve the final fold.

The folding template of the present invention provides a simple and virtually fail-safe method for neatly and compactly folding a fitted sheet. As shown in the sequence of FIGS. 3-7, the panel 10 is fully opened and laid into the fitted sheet 20. In particular, the fitted sheet is stretched slightly to fit around the perimeter of the panel 10, with the ends 21, 22 and sides 23, 24 snugly engaged around the panel. The corners 18 of the panel 10 may be rounded to correspond to the rounded corners 26 of the fitted sheet created by the elastic bands within the sheet.

With the fitted sheet wrapped around the panel 10, the first fold along fold line 12 is made by bringing end 22 in overlapping arrangement with end 21, as shown in FIG. 4. The resulting folded panel and sheet is shown in FIG. 5. It can be appreciated that the fold line 14 extends along the two overlapping portions of the panel 10, so that the fold line 14 in each portion also overlap. The second fold is then made along fold line 14, as shown in FIG. 6, resulting in a folded panel and sheet as depicted in FIG. 7. The final fold is made along fold line 16 so that the result is a fitted sheet folded into a generally rectangular shape.

The panel 10 has a thickness t that is sufficient for the overall panel 10 to resist bending or buckling when the fitted sheet 20 is wrapped around the panel. On the other hand, this thickness t is sufficiently thin to accommodate three folds without adding significant thickness to the folded fitted sheet. In a preferred embodiment, the panel 10 is a polypropylene sheet having a thickness of about 0.06 or 1/16 inches. After three folds, the overall thickness of the folded panel is only about 0.24 or ¼ inches. A fitted sheet may have a thickness of half the folding template panel 10 and an overall folded thickness when pressed flat of less than about ⅛ inch. While the ¼ inches of the folded panel is twice the thickness of the folded sheet, even this increased thickness is significantly less than the overall thickness of a badly folded fitted sheet. The folding template of the present invention ensures a repeatable folding process resulting in a tightly folded fitted sheet having a total thickness of less than ½ inch.

The folding template of the present invention can be sized for any size fitted sheet from king to single. The arrangement of fold lines 12, 14 and 16 is unchanged regardless of the size of the fitted sheet. The folding process is also unchanged, although it is certainly less cumbersome for a single size fitted sheet than for a king size sheet.

In the illustrated embodiment, the fold lines are arranged so that the panel, and therefore the fitted sheet, is essentially folded in half with each fold. Alternatively, the fold lines may be modified to achieve other folding patterns. For instance, the first fold line 12 may include two fold lines so that the panel is folded in thirds. Thus, as illustrated in FIG. 8, the modified folding template panel 30 may include two fold lines 32 and a single second fold line 34. With this embodiment, the two sides of the panel 30, and consequently the fitted sheet, are folded inward along fold lines 32 overlapping each other and the center third of the panel. The resulting folded panel is then fold over onto itself along fold line 34 so that the resulting folded fitted sheet is one-sixth its original size. This folding pattern may be preferable for smaller fitted sheets, such as single or double sized sheets.

For any fold pattern, the folding template includes at fold lines to accomplish at least two orthogonal folds—i.e., successive folds that are at right angles to each other. Thus, in the embodiment of FIG. 1, the panel 10 the first fold is along fold line 12, while the second fold is perpendicular along fold line 14. The final fold is perpendicular to the second fold along fold line 16. Likewise, with the embodiment of FIG. 8, the initial folds along fold line 32 are perpendicular to the second fold along fold line 34. This approach ensures a compact and uniform folded sheet, while also maintaining the fitted sheet tight across the folded panel portions.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

What is claimed is:

1. A folding template for a fitted mattress sheet, comprising:
a generally flat panel having a length dimension and a width dimension that is substantially equal to the length and width of the fitted sheet when it is mounted on a mattress; and
a first fold line defined parallel to one of the length and the width dimension and a second orthogonal fold line defined parallel to the other of the length and the width dimension, said first fold line being configured to permit folding said panel over onto itself with the fitted sheet engaged thereon and said second fold line being configured to permit a second orthogonal fold of said panel and fitted sheet over onto itself a second time.

2. The folding template of claim 1, further comprising a third fold line orthogonal to said second fold line and configured to permit a third orthogonal fold of said panel and fitted sheet over onto itself a third time.

3. The folding template of claim 1, wherein said first and second fold lines are defined by hinge elements attached to said panel.

4. The folding template of claim 3, wherein said hinge elements are defined by lines of reduced thickness of said panel.

5. The folding template of claim 3, wherein said hinge elements include mechanical hinges connecting separate portions of said panel along said first and second fold lines.

6. The folding template of claim 1, wherein said panel is formed of a polypropylene.

7. The folding template of claim 1, wherein said panel has a thickness of less than 0.1 inches.
